(19) United States
(12) Patent Application Publication
(10) Pub. No.: US 2016/0013524 A1
(43) Pub. Date: Jan. 14, 2016

(54) BATTERY PACK

(71) Applicant: NEC ENERGY DEVICES, LTD., Sagamihara-shi, Kanagawa (JP)

(72) Inventor: Kazunori MARUOKA, Sagamihara-shi (JP)

(73) Assignee: NEC ENERGY DEVICES, LTD., Sagamihara-shi, Kanagawa (JP)

(21) Appl. No.: 14/766,895

(22) PCT Filed: Jan. 30, 2014
(86) PCT No.: PCT/JP2014/052139

§ 371 Date: Aug. 10, 2015

(30) Foreign Application Priority Data
Feb. 26, 2013 (JP) 2013-036071

(51) Int. Cl. H01M 10/48

(52) U.S. Cl. CPC H01M 10/488

(57) ABSTRACT

In order to provide a battery pack that can let a user accurately know the state of charge of the battery pack, a battery pack 100 of the present invention includes: a plurality of chip-type LEDs 71 to 75; a printed board 40 on which the plurality of chip-type LEDs 71 to 75 are placed; a second casing 20 where LED openings 21 to 25 are provided in such a way as to correspond to the plurality of chip-type LEDs 71 to 75; and moisture-proof resin 60 that is provided in such a way as to cover the plurality of chip-type LEDs 71 to 75 on the board, wherein height of the moisture-proof resin 60 between the plurality of chip-type LEDs 71 to 75 from a board surface of the printed board 40 is lower than height of the moisture-proof resin 60 on the plurality of chip-type LEDs 71 to 75 from the board surface of the printed board 40.

### TECHNICAL FIELD

The present invention relates to a battery pack equipped with an indicator that includes a plurality of LEDs.

### BACKGROUND ART

In order to display a charge level of a built-in secondary battery in a battery pack, one that is equipped with an indicator including a plurality of LEDs has been known. For example, in an indicator that is equipped with five LEDs, all the five LEDs are turned on for a full-charge level. As the charge level decreases, the number of LEDs being turned on is gradually decreased, thereby letting a user know the remaining amount of battery capacity and encouraging the user to appropriately recharge the battery.

For example, what is disclosed in Patent Document 1 (JP2008-91234A) is an electronics device that includes a circuit board on which a plurality of LEDs are placed side by side and a casing that includes a plurality of light windows in such a way that beams of the LEDs fixed on the circuit board are independently released out of the casing, with partition walls provided on boundaries of the LEDs fixed on the circuit board.
Patent Document 1: JP2008-91234A

### SUMMARY OF THE INVENTION

### Problems to be Solved by the Invention

However, a battery pack that is used in an electric motorcycle or the like may be used in rain, or may be left in rain after being laid on its side. Therefore, it is important to give waterproof properties to the battery pack.

In the battery pack, a printed board on which a circuit is mounted to manage and control the secondary battery is provided. In order to give waterproof properties, the printed board is coated with moisture-resistant resin.

If a plurality of chip-type LEDs, which constitute an indicator for showing the charge level, are mounted on the above-described printed board, the LEDs are coated with the above-described moisture-resistant resin as well.

The configuration of a conventional battery pack in which the printed board coated with the above moisture-resistant resin is provided will be described.

FIG. 8 is a perspective view of the conventional battery pack. In a casing of the battery pack, a battery cell assembly (which is for example made up of lithium-ion-battery unit cells that are connected in series or parallel, or in both), and a printed board on which a circuit for controlling and managing the battery cell assembly is mounted are placed. On the casing of the battery pack, an indicator section is disposed in order to let a user know the state of charge of the battery cell assembly.

FIG. 9 schematically shows the cross-sectional structure of the indicator section. On the printed board, five chip-type LEDs are mounted. The upper portions of the chip-type LEDs are covered with moisture-resistant resin, which has been applied to give waterproof properties. Openings are provided on the casing for each of the chip-type LEDs. This makes it possible to check, from outside the casing, whether each of the chip-type LEDs is being turned on or off.

Usually, on the surface of a light emitting section of the chip-type LED, anti-reflection agents or fine uneven treatment (anti-glare treatment) have been applied. However, such functionality could be lost when the chip-type LED is covered with moisture-resistant resin. It was found that, if the LEDs are placed adjacent to each other, light propagates through the moisture-resistant resin, resulting in the leakage of light into the adjacent LEDs.

For example, what is shown in the example of FIGS. 8 and 9 is the case where only the first and second chip-type LEDs from the right are being switched on. However, in this case, as indicated by arrow inside the moisture-resistant resin, light leaks from the LED that is emitting the light. As a result, a user might visually recognize that the third chip-type LED from the right is emitting light, even though the third chip-type LED is actually not emitting light.

As described above, when a plurality of LEDs coated with moisture-resistant resin are used as the indicator section of the battery pack, the moisture-resistant resin functions as a medium that conveys the light emitted from the LEDs. Accordingly, a user might see the LED that is not emitting light as one that is emitting light. The problem is that this configuration makes it difficult to let the user know exactly the state of charge of the battery pack.

Incidentally, Patent Document 1 (JP2008-91234A) discloses the method of preventing the light from leaking by laying partition walls between LEDs or taking other steps. However, such a method leads to another problem, or an increase in costs.

### Means for Solving the Problems

To solve the above problems, a battery pack of the present invention includes: a plurality of LEDs; a board on which the plurality of LEDs are placed; a casing where openings are provided in such a way as to correspond to the plurality of LEDs; and moisture-proof resin that is provided in such a way as to cover the plurality of LEDs on the board, wherein height of the moisture-proof resin between the plurality of LEDs from a surface of the board is lower than height of the moisture-proof resin on the plurality of LEDs from the surface of the board.

### Advantages of the Invention

In the battery pack of the present invention, the height of the moisture-proof resin between the plurality of LEDs from the board surface is set lower than the height of the moisture-proof resin on the plurality of LEDs from the board surface. According to the battery pack of the present invention, even if the moisture-proof resin functions as a medium that conveys the light emitted from the LEDs, there is almost no leakage of light into the adjacent LEDs, and a LED that is not emitting light is therefore not mistaken as emitting light. As a result, it is possible to let a user accurately know the state of charge of the battery pack.

Moreover, in the battery pack of the present invention, there is no need to put partition walls between the LEDs. Therefore, it is possible to reduce costs.

### BRIEF DESCRIPTION OF THE DRAWINGS

FIG. 1 is an exploded perspective view of a battery pack 100 according to the present embodiment.

FIG. 2 is a diagram for explaining a production process of a printed board 40 of the battery pack 100 of the present embodiment.

FIG. 3 is a perspective view of the battery pack 100 of the present embodiment.

FIG. 4 is a cross-sectional view of FIG. 3 taken along A-A′.

FIG. 5 is a diagram showing a cross section of a battery pack 100 according to a comparative example.

FIG. 6 is a diagram showing a cross section of a battery pack 100 according to a comparative example.

FIG. 7 is a diagram showing a cross section of a battery pack 100 according to a comparative example.

FIG. 8 is a perspective view of a conventional battery pack.

FIG. 9 is a diagram showing the cross-sectional structure of an indicator section of the conventional battery pack.

### BEST MODE FOR CARRYING OUT THE INVENTION

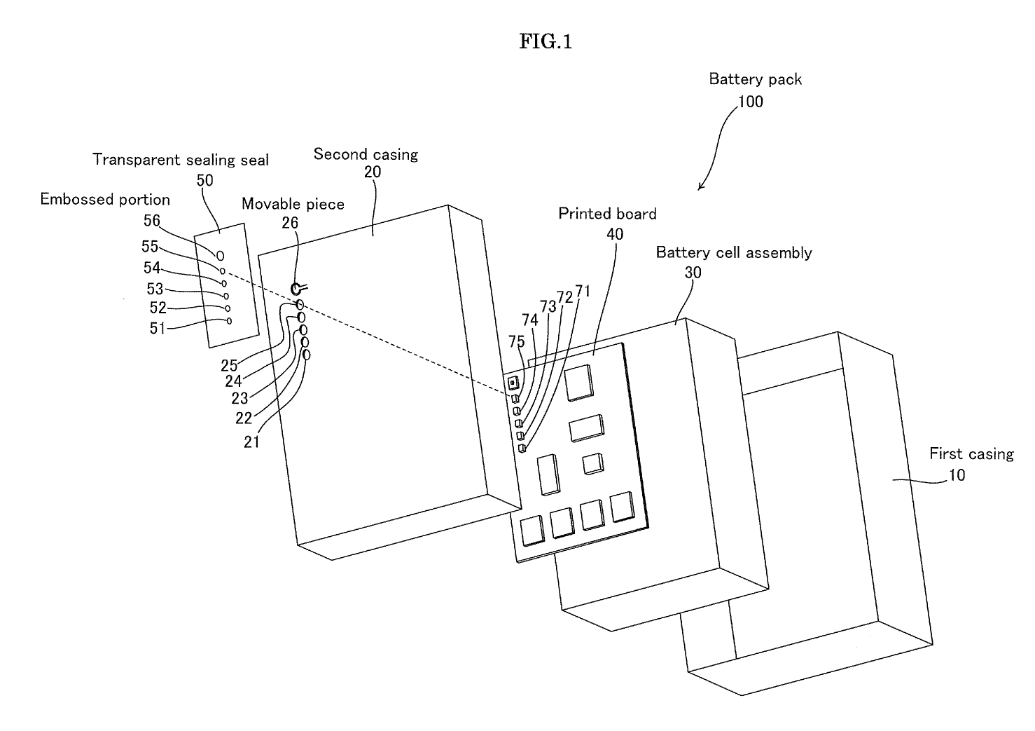

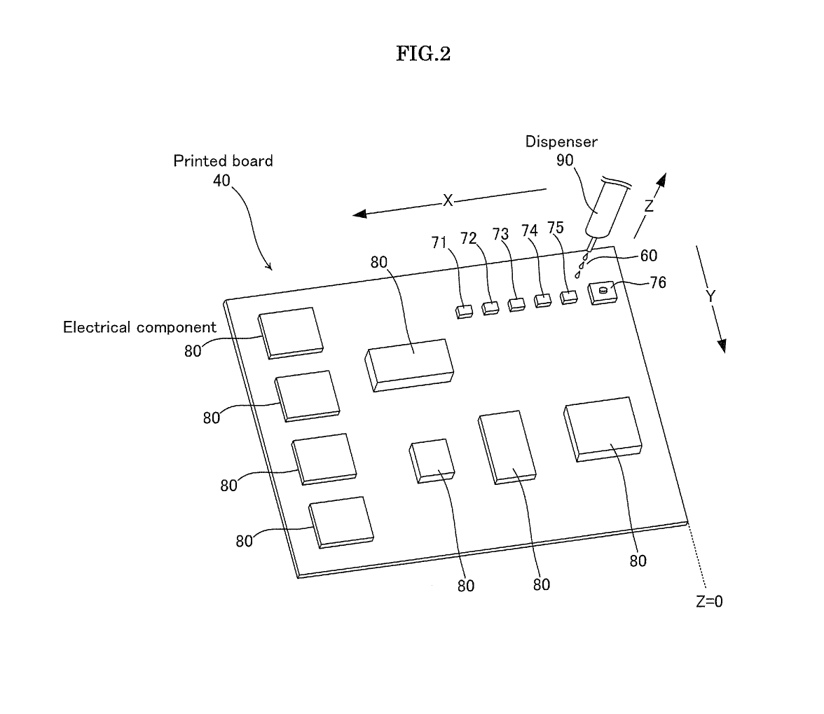

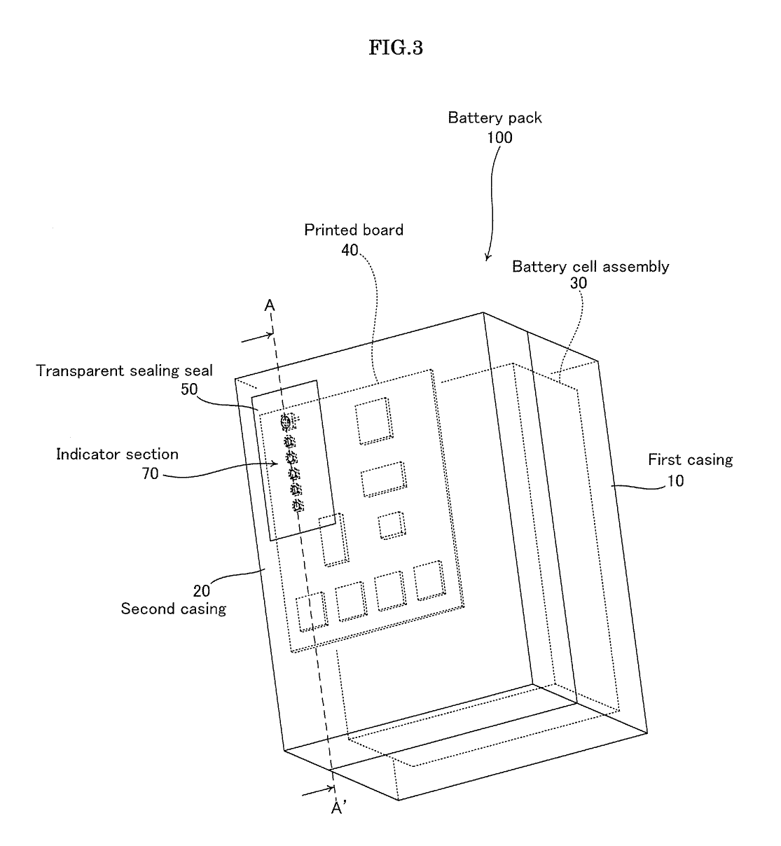

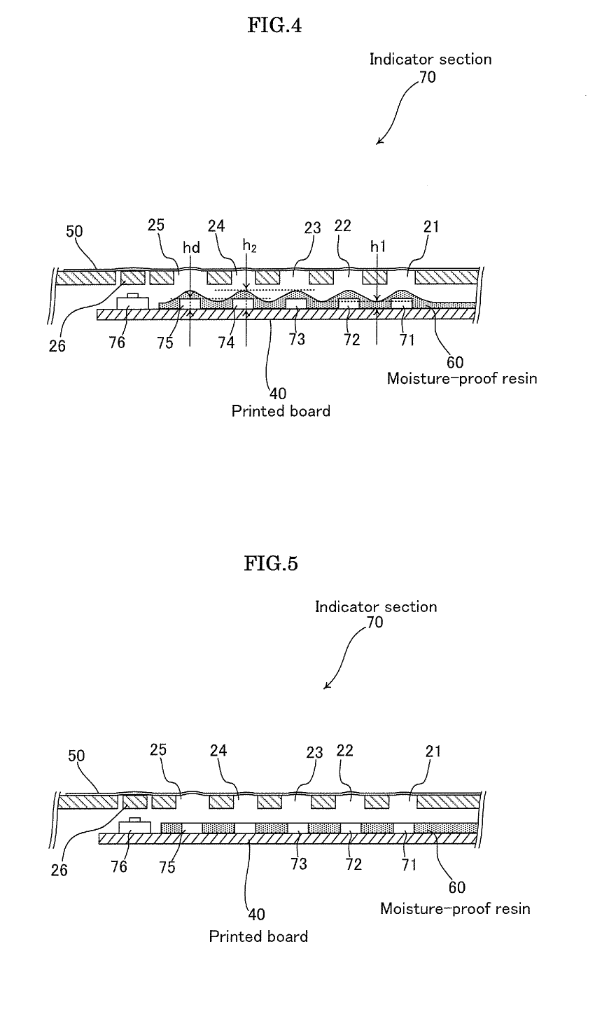

Hereinafter, an embodiment of the present invention will be described with reference to the accompanying drawings. FIG. 1 is an exploded perspective view of a battery pack 100 according to the present embodiment. FIG. 2 is a diagram for explaining a production process of a printed board 40 of the battery pack 100 of the present embodiment. FIG. 3 is a perspective view of the battery pack 100 of the present embodiment. FIG. 4 is a cross-sectional view of FIG. 3 taken along A-A′.

The battery pack 100 includes a housing that is made up of a first casing 10 and a second casing 20; major components are housed in the housing. For example, the major components that are housed in the first casing 10 and the second casing 20 include a battery cell assembly 30, which is made up of lithium-ion-battery unit cells that are connected in series or parallel, or in both; a printed board 40, on which a circuit for managing and controlling the battery cell assembly 30 is provided; and electrical wiring and the like, which are not shown.

On the printed board 40, chip-type LEDs 71 to 75 and a switch 76, which make up an indicator section 70, are placed and fixed by soldering or the like. Moreover, on the printed board 40, besides the chip-type LEDs 71 to 75 and the switch 76, a plurality of electrical components 80 are placed and fixed by soldering or the like.

On the second casing 20, LED openings 21 to 25 are provided in such a way as to correspond to the chip-type LEDs 71 to 75, allowing a user to check, from outside the housing, whether the chip-type LEDs 71 to 75 are on or off. Moreover, on the second casing 20, a movable piece 26 is provided in such a way as to correspond to the switch 76. The switch 76 is turned on by an external force that is applied through the movable piece 26.

In a portion of the second casing 20 where the indicator section 70 is provided, a transparent sealing seal 50, on which embossed portions 51 to 56 are provided, is placed to seal the LED openings 21 to 25 and the movable piece 26.

According to the above-described configuration, for example, during a period of time in which a user is pushing the switch 76, the chip-type LEDs 71 to 75 are turned on or off to notify a user of the charge level of the battery cell assembly 30.

After a step of mounting the chip-type LEDs 71 to 75 and the electrical components 80 on the printed board 40 by soldering, a step of applying moisture-proof resin 60 to the printed board 40 is carried out. In this manner, the printed board 40 is given waterproof properties. As such moisture-resistant resin, for example, SE9187L manufactured by Dow Corning Toray Co., Ltd. may be used.

FIG. 2 shows a step of applying the moisture-proof resin 60 to the printed board 40. The printed board 40 on which the chip-type LEDs 71 to 75, the switch 76 and the electrical components 80 have been fixed by soldering is placed on an XY stage, which is not shown in the diagram. On the XY stage, a dispenser 90, which supplies the moisture-proof resin 60, is provided. The printed board 40 is moved by the XY stage when the moisture-proof resin 60 is supplied from the dispenser 90. As a result, the chip-type LEDs 71 to 75, switch 76 and electrical components 80 on the printed board 40 are integrally covered with the moisture-proof resin 60. Incidentally, some of the electrical components 80 are larger in height than the chip-type LEDs 71 to 75. The electrical components 80 that are larger in height than the chip-type LEDs 71 to 75, too, are covered with the moisture-proof resin 60 together with the chip-type LEDs 71 to 75.

In the case of the battery pack 100 of the present embodiment, the moving speed of the XY stage and other factors are adjusted, so that height h₁ of the moisture-proof resin 60 between the chip-type LEDs 71 to 75 from the board surface of the printed board 40 is set smaller than height h₂ of the moisture-proof resin 60 on the chip-type LEDs 71 to 75 from the board surface of the printed board 40, as shown in FIG. 4. When compared with height h_{d} of the chip-type LEDs 71 to 75, h₁<h_{d}<h₂.

According to the battery pack 100 of the present invention, even if the moisture-proof resin 60 functions as a medium that conveys the light emitted from the chip-type LEDs 71 to 75, there is almost no leakage of light into the adjacent LEDs, and a LED that is not emitting light is therefore not mistaken as emitting light. As a result, it is possible to let a user accurately know the state of charge of the battery pack. Moreover, in the case of the battery back 100 of the present invention, there is no need to put partition walls between the LEDs. Therefore, it is possible to reduce costs.

Incidentally, height h₁ of the moisture-proof resin 60 between the chip-type LEDs 71 to 75 is set smaller than height h₂ of the moisture-proof resin 60 on the chip-type LEDs 71 to 75. To realize this configuration, the amount of moisture-proof resin 60 being supplied from the dispenser 90 is kept constant, and the moving speed of the XY stage is adjusted. Other methods, described below, may be used as well.

According to a first method, while the moving speed of the XY stage is kept constant, the amount of moisture-proof resin 60 being supplied from the dispenser 90 is changed according to the place where the moisture-proof resin 60 is supplied. As a result, height h₁ of the moisture-proof resin 60 between the chip-type LEDs 71 to 75 is set smaller than height h₂ of the moisture-proof resin 60 on the chip-type LEDs 71 to 75.

According to a second method, after the moisture-proof resin 60 is formed on the printed board 40 without any difference in height, a certain amount of the moisture-proof resin 60 is scrapped off between the chip-type LEDs 71 to 75. As a result, height h₁ of the moisture-proof resin 60 between the chip-type LEDs 71 to 75 is set smaller than height h₂ of the moisture-proof resin 60 on the chip-type LEDs 71 to 75.

A comparison was made between the battery pack 100 of the present embodiment shown in FIG. 4 and battery packs 100 of comparative examples shown in FIGS. 5 to 7 in terms of the leakage of light into adjacent LEDs and water resistance. The results will be shown below.

In the battery pack 100 of a comparative example of FIG. 5, the height of the moisture-proof resin 60 is set almost equal to that of the chip-type LEDs 71 to 75.

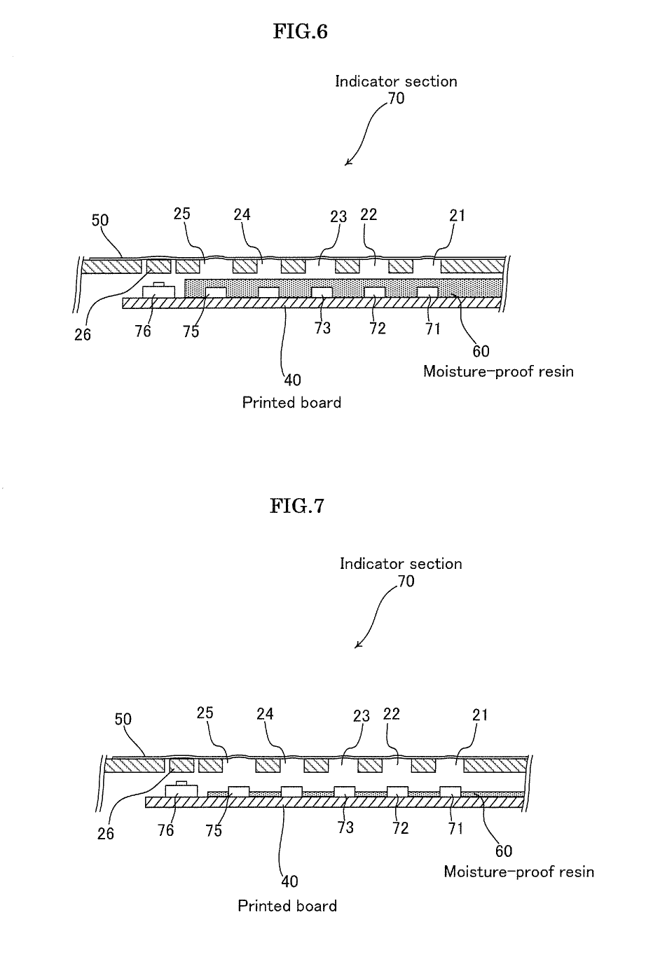

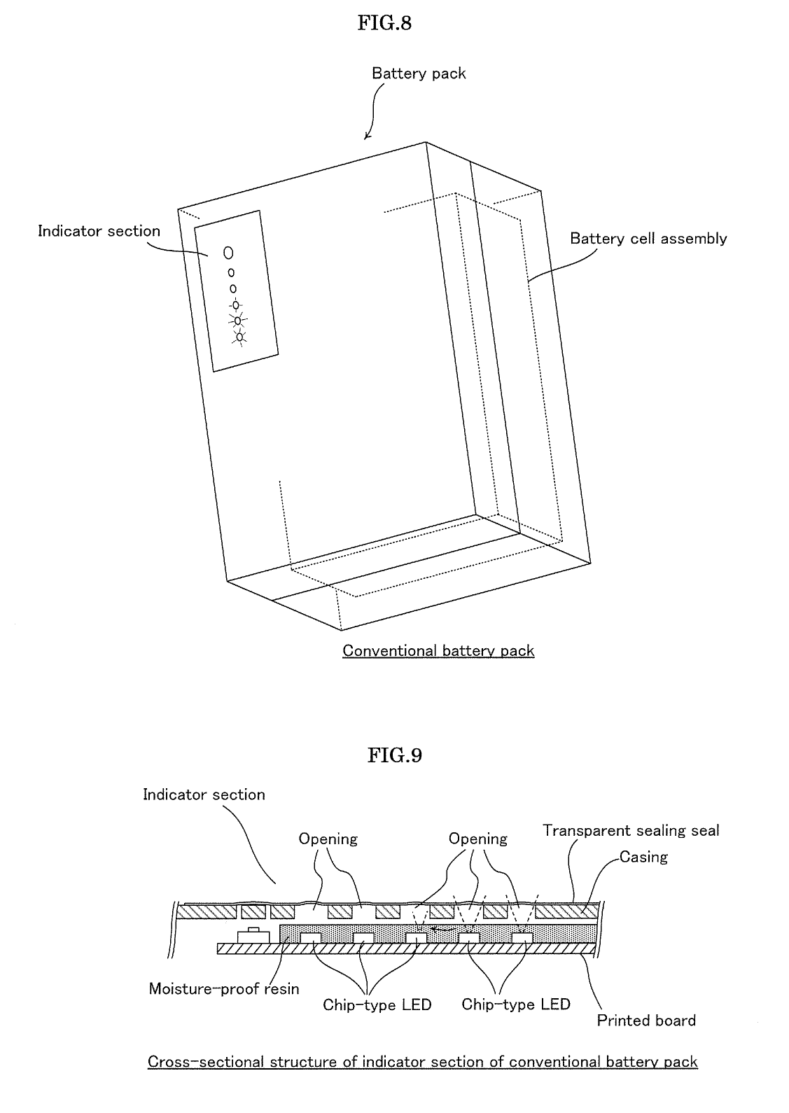

In the battery pack 100 of a comparative example of FIG. 6, the height of the moisture-proof resin 60 is set higher than that of the chip-type LEDs 71 to 75.

In the battery pack 100 of a comparative example of FIG. 7, the height of the moisture-proof resin 60 is set lower than that of the chip-type LEDs 71 to 75.

Table 1 shows the results of experiments on light leakage and water resistance for the battery pack 100 of the present embodiment, which has the above-described configuration, and the battery packs 100 of the comparative examples.

TABLE 1

| | Light leakage | Water resistance |
|---|---|---|
| Present invention | Not observed | ◯ |
| (FIG. 4) | | |
| Comparative example | Observed | Δ |
| (FIG. 5) | | |
| Present invention | Observed | ◯ |
| (FIG. 6) | | |
| Comparative example | Not observed | Δ |
| (FIG. 7) | | |

In column “water resistance”, “◯” means that the water resistance is good; “Δ” means that there is a possibility of water permeation on the surface of the printed board 40 as a result of water adhering thereto for a long time.

As described above, in the battery pack 100 of the present invention, the height of the moisture-proof resin 60 between a plurality of the chip-type LEDs 71 to 75 from the board surface of the printed board 40 is set lower than the height of the moisture-proof resin 60 on a plurality of the chip-type LEDs 71 to 75 from the board surface of the printed board 40. According to the battery pack 100 of the present invention, even if the moisture-proof resin 60 functions as a medium that conveys the light emitted from the LEDs, there is almost no leakage of light into the adjacent LEDs, and a LED that is not emitting light is therefore not mistaken as emitting light. As a result, it is possible to let a user accurately know the state of charge of the battery pack 100.

Moreover, in the battery pack 100 of the present invention, the moisture-proof resin 60 is provided on a plurality of the chip-type LEDs 71 to 75 as well. Therefore, the battery pack 100 is excellent in water resistance.

Moreover, in the battery pack 100 of the present invention, there is no need to put partition walls between the LEDs . Therefore, it is possible to reduce costs.

### INDUSTRIAL APPLICABILITY

The present invention relates to a battery pack that includes a plurality of LEDs coated with moisture-resistant resin as an indicator section in order to let a user know a remaining amount of battery capacity. In such a battery pack, the moisture-resistant resin functions as a medium that conveys light emitted from the LEDs. As a result, a user might see the LED that is not emitting light as one that is emitting light. The problem is therefore that this configuration makes it difficult to let the user know exactly the state of charge of the battery pack. In the battery pack of the present invention, the height of the moisture-proof resin between a plurality of LEDs from the board surface is set lower than the height of the moisture-proof resin on the plurality of LEDs from the board surface. According to the battery pack of the present invention, even if the moisture-resistant resin functions as a medium that conveys the light emitted from the LEDs, there is almost no leakage of light into the adjacent LEDs, and a LED that is not emitting light is therefore not mistaken as emitting light. As a result, it is possible to let a user accurately know the state of charge of the battery pack. Therefore, the present invention is very high in industrial applicability.

### EXPLANATION OF REFERENCE SYMBOLS

10: First casing
20: Second casing
21: LED opening
22: LED opening
23: LED opening
24: LED opening
25: LED opening
26: Movable piece
30: Battery cell assembly
40: Printed board
50: Transparent sealing seal
51: Embossed portion
52: Embossed portion
53: Embossed portion
54: Embossed portion
55: Embossed portion
56: Embossed portion
60: Moisture-proof resin
70: Indicator section
71: Chip-type LED
72: Chip-type LED
73: Chip-type LED
74: Chip-type LED
75: Chip-type LED
76: Switch
80: Electrical component
90: Dispenser
100: Battery pack

1. A battery pack comprising:
a plurality of LEDs;
a board on which the plurality of LEDs are placed;
a casing where openings are provided in such a way as to correspond to the plurality of LEDs; and
moisture-proof resin that is provided in such a way as to cover the plurality of LEDs on the board, wherein
height of the moisture-proof resin between the plurality of LEDs from a surface of the board is lower than height of the moisture-proof resin on the plurality of LEDs from the surface of the board.

2. The battery pack according to claim 1, wherein
the plurality of LEDs are covered with the moisture-proof resin.

3. The battery pack according to claim 1, wherein:
a component that is higher than the plurality of LEDs is placed on the board together with the plurality of LEDs; and
the component is covered with the moisture-proof resin integrally with the plurality of LEDs.

4. The battery pack according to claim 2, wherein:
a component that is higher than the plurality of LEDs is placed on the board together with the plurality of LEDs; and
the component is covered with the moisture-proof resin integrally with the plurality of LEDs.
